(19) United States
(12) Patent Application Publication
(10) Pub. No.: US 2012/0014512 A1
(43) Pub. Date: Jan. 19, 2012

(54) RADIOGRAPHY APPARATUS AND CONTROL METHOD THEREOF

(75) Inventors: Hyun Sun KIM, Hwaseong-si (KR); Hyung Chan KIM, Suwon-si (KR); Sung Nam KIM, Goonpo-si (KR); Seung Woo SHIN, Yongin-si (KR)

(73) Assignee: SAMSUNG ELECTRONICS CO., LTD., Suwon-si (KR)

(21) Appl. No.: 13/166,889

(22) Filed: Jun. 23, 2011

(30) Foreign Application Priority Data
Jul. 13, 2010 (KR) 10-2010-0067309

(51) Int. Cl. H05G 1/02

(52) U.S. Cl. 378/189

(57) ABSTRACT

A radiography apparatus and a control method thereof are provided. With provision of a user centered input unit, automated horizontal and rotational movement of a detector may be performed, enabling automated full-body radiography.

### CROSS-REFERENCE TO RELATED APPLICATION

This application claims the benefit of Korean Patent Application No. 2010-0067309, filed on Jul. 13, 2010 in the Korean Intellectual Property Office, the disclosure of which is incorporated herein by reference.

### BACKGROUND

1. Field

Methods and apparatuses consistent with the exemplary embodiments relate to a radiography apparatus to enable automated horizontal movement of a detector and a control method thereof.

2. Description of the Related Art

Radiography is a very useful diagnosis tool in the field of medicine. A related art radiography apparatus includes an arm, to which a radiation emitter is coupled, and a detector to record radiation having passed through a patient to enable formation of an image. The position and angle of the related art arm and detector may need to be adjusted in the course of performing radiography. For example, moving the detector may necessitate vertical movement of the arm, or angular adjustment of the detector may necessitate rotating the arm clockwise or counterclockwise. Moreover, since such adjustment in the position and angle of the arm and the detector entirely requires a user to directly control movement and rotation buttons provided on an input unit, the user may have difficulty accurately and rapidly adjusting the position of the detector. In addition, horizontally moving the detector to perform full-body radiography may necessitate troublesome operations of the arm and the detector, thus making it difficult to perform accurate radiography.

### SUMMARY

Therefore, it is an aspect of the exemplary embodiments to provide a radiography apparatus to enable automated horizontal movement of a detector through a simplified operation, and a control method thereof.

Additional aspects of the exemplary embodiments will be set forth in part in the description which follows and, in part, will be obvious from the description, or may be learned by practice of the exemplary embodiments.

In accordance with one aspect of the exemplary embodiments, a radiography apparatus including an arm to which a radiation emitter is coupled and a detector to record radiation having passed through an object so as to form a radiography image, further includes an input unit to input a change in the position of the detector, and a control unit to control motors used to drive the arm and the detector so as to move the detector in a direction input through the input unit.

The detector may be movable vertically and horizontally.

The arm may be a U-shaped arm.

The input unit may include a direction input device to input a movement direction of the detector.

The control unit may control the motors by calculating a movement distance and a rotating angle of the arm and the detector.

In accordance with another aspect of the exemplary embodiments, a method to control movement of a detector includes determining a rotating direction of an arm based on a movement direction of the detector so as to rotate the arm by a control unit, and correcting a position of the detector by the control unit after rotation of the arm is complete.

The rotation of the arm may include determining whether or not the arm is rotatable in the determined rotating direction by the control unit, moving the arm downward by the control unit if the arm is not rotatable in the determined rotating direction, and rotating the arm in the determined rotating direction by the control unit if the arm is rotatable in the determined rotating direction.

The correction of the position of the detector may include correcting an angle of the detector, which is deviated from a horizontal direction due to rotation of the arm, by the control unit, and after correcting the angle of the detector, correcting a height of the detector, which is vertically moved due to rotation of the arm, by the control unit.

The control unit may repeat the control operations until the detector moves to an input position.

The control unit may control movement of the detector based on information about movable ranges of the arm and the detector with respect to previously input angles of the arm and the detector.

The control unit may control movement of the detector based on information about movable ranges of the arm and the detector obtained from sensors attached to the arm and the detector.

The control unit may control movement of the detector based on a combination of information about movable ranges of the arm and the detector with respect to previously input angles of the arm and the detector and information about movable ranges of the arm and the detector obtained from sensors attached to the arm and the detector.

The arm may be a U-shaped arm.

In accordance with another aspect of the exemplary embodiments, a method to perform full-body radiography on an object using a radiography apparatus includes horizontally moving a detector by a control unit if full-body radiography is chosen, and adjusting a radiation dose emitted from a radiation emitter to provide an evenly distributed radiation dose throughout the object by the control unit during horizontal movement of the detector.

The provision of the evenly distributed radiation dose throughout the object may include determining a rotating angle of an arm by the control unit, calculating a distance between the radiation emitter and the object after the arm is rotated by the determined rotating angle by the control unit, and adjusting the radiation dose to provide the evenly distributed radiation dose throughout the object by the control unit based on the calculated distance.

The provision of the evenly distributed radiation dose throughout the object may include adjusting a distance between the radiation emitter and the object to a constant value by the control unit to provide the evenly distributed radiation dose throughout the object.

In accordance with a further aspect of the exemplary embodiments, a control method of a radiography apparatus includes simultaneously controlling motors used to drive an arm and a detector by a control unit if a movement direction of the detector is input through an input unit, horizontally moving the detector in the input movement direction by controlling the motors by the control unit, and performing radiography of an object after stopping movement of the detector if the detector reaches a target position.

In accordance with a further aspect of the exemplary embodiments, the arm may be a U-shaped arm.

In accordance with a further aspect of the exemplary embodiments, the detector may be movable in a vertical direction and a horizontal direction.

### BRIEF DESCRIPTION OF THE DRAWINGS

These and/or other aspects of the exemplary embodiments will become apparent and more readily appreciated from the following description of the exemplary embodiments, taken in conjunction with the accompanying drawings of which:

FIG. 1 is a perspective view of a radiography apparatus according to an exemplary embodiment;

FIG. 2 is a schematic view of an input unit according to the exemplary embodiment;

FIG. 3 is a control block diagram of the radiography apparatus according to the exemplary embodiment;

FIG. 4 is a flow chart illustrating the sequence of controlling movement of a detector by a control unit according to the exemplary embodiment; and

FIG. 5 is a flow chart illustrating the sequence of controlling full-body radiography by the control unit according to the exemplary embodiment.

### DETAILED DESCRIPTION

Reference will now be made in detail to a radiography apparatus and a control method thereof according to the exemplary embodiments, examples of which are illustrated in the accompanying drawings, wherein like reference numerals refer to like elements throughout.

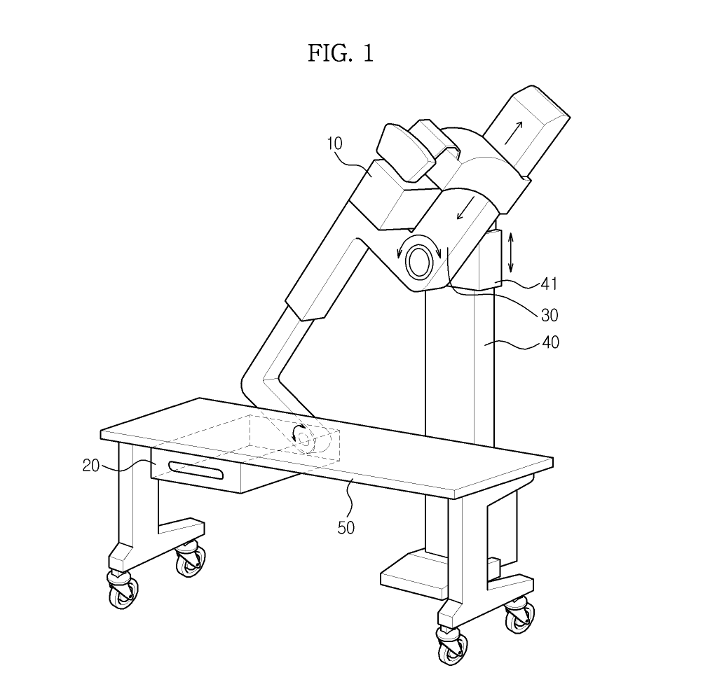

FIG. 1 is a perspective view of a radiography apparatus according to an exemplary embodiment.

The radiography apparatus according to the exemplary embodiment includes an arm 30, to which a radiation emitter 10 and a detector 20 are coupled. The arm 30 includes a motor for vertical movement of the radiation emitter 10 and a motor for rotation of the detector 20. In the present exemplary embodiment, the arm 30 may be a U-shaped arm. The radiation emitter 10 coupled to the arm 30 serves to emit radiation to a target object, and the detector 20 serves to record radiation having passed through the object. In addition, the radiography apparatus according to the exemplary embodiment includes a guide member 40 to which the arm 30 is coupled. The guide member 40 includes a motor for vertical movement and rotational movement of the arm 30.

The arm 30 is coupled to a guide 41 of the guide member 40. The guide 41 is vertically movable on a guide rail of the guide member 40. Thus, the arm 30 coupled to the guide 41 is vertically movable on the guide member 40.

The arm 30 is also rotatably coupled to the guide 41. Thus, the arm 30 is rotatable clockwise or counterclockwise about a rotating shaft.

The radiation emitter 10 is coupled to the arm 30 in the same manner as the arm 30 that is vertically movably coupled to the guide member 40. Thus, the radiation emitter 10 is vertically movable through movement of the arm 30.

The detector 20 is rotatably coupled to the arm 30. Thus, the detector 20 is rotatable clockwise or counterclockwise about a rotating shaft.

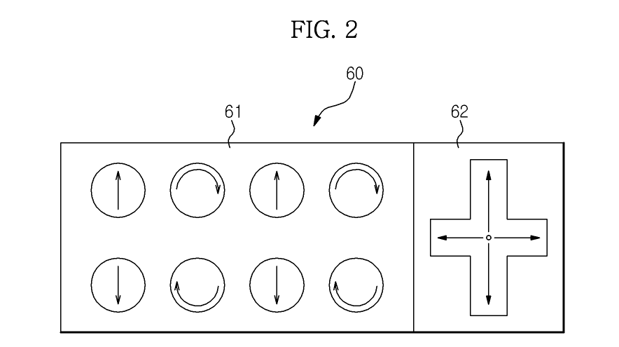

FIG. 2 is a schematic view of an input unit 60 according to the exemplary embodiment.

The input unit 60 according to the exemplary embodiment includes an input button 62 indicating movement directions of the detector 20 for movement of the detector 20 in various directions. When using a related art input unit, it may be necessary for a user to manually adjust movement and rotation of both the arm and the detector. When using the related art input unit, even if the user wants to adjust only movement of the detector, movement of the arm may be simultaneously adjusted. That is, the related art input unit is focused on the control of movements of mechanical structures. However, in the present exemplary embodiment, a control unit 70 may automatically control the arm 30 and the detector 20 using the input button 62 that indicates movement directions of the detector 20, realizing a user-centered input unit including the direction indicating button of FIG. 2. The input button is given only by way of one example, and of course, various other configurations to enable the user to input the movement direction of the detector 20 may be provided.

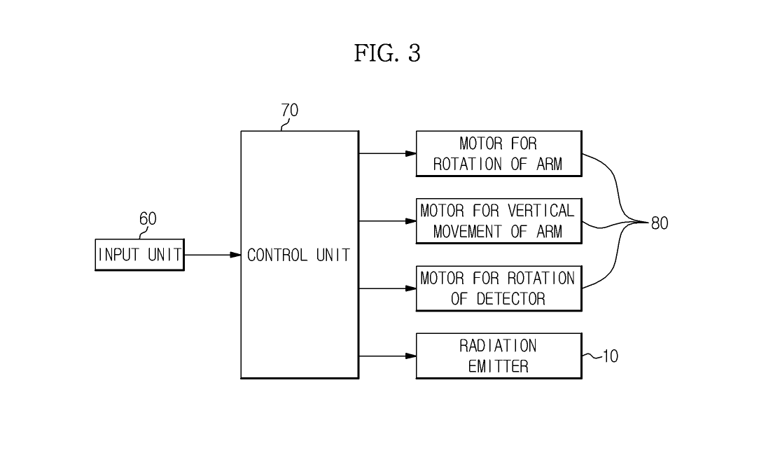

FIG. 3 is a control block diagram of the radiography apparatus according to the exemplary embodiment.

In operation of the radiography apparatus according to the exemplary embodiment, if the user inputs the movement direction of the detector 20 using the input unit 60, the control unit 70 controls motors 80 used respectively to move and rotate the arm 30 and the detector 20 so as to move the detector 20 in the input movement direction. Differently from the related art input unit in which it may be necessary for the user to manually control operations of the arm and the detector, according to the present exemplary embodiment, the user may simply input the movement direction of the detector 20 using the input unit 60, after which the control unit 70 automatically controls operations of the arm 30 and the detector 20 so as to move the detector 20.

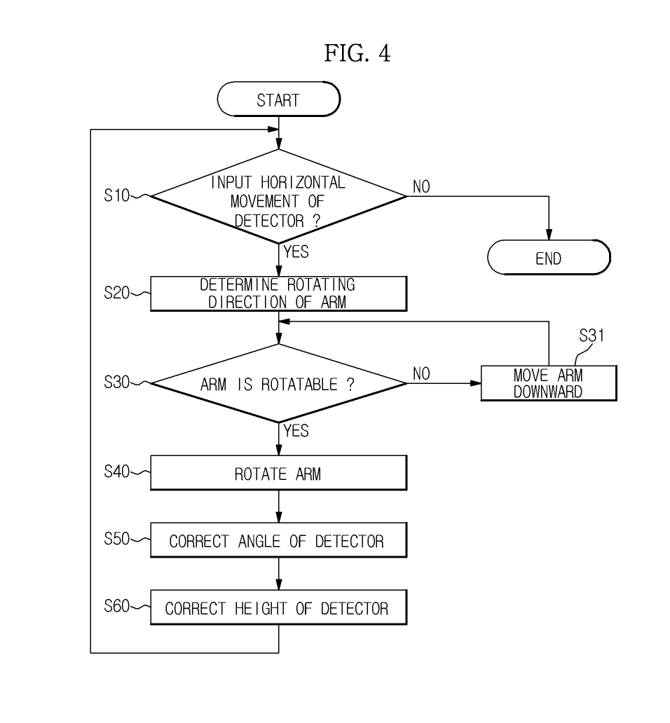

FIG. 4 is a flow chart illustrating the sequence of controlling movement of the detector 20 by the control unit 70 according to the exemplary embodiment.

The control unit 70 provided in the radiography apparatus according to the exemplary embodiment first determines whether or not horizontal movement of the detector 20 is input (operation S10). A control operation is ended if the horizontal movement of the detector 20 is not input, or proceeds to the following operation if the horizontal movement is input.

If the horizontal movement of the detector 20 is input, the control unit 70 determines a rotating direction of the arm 30 (operation S20). That is, the control unit 70 determines the rotating direction of the arm 30 corresponding to the movement direction of the detector 20.

If the rotating direction of the arm 30 is determined, the control unit 70 determines whether or not the arm 30 is in a rotatable state (operation S30). Since it is impossible to rotate the arm 30 if the detector 20 comes into close contact with a table 50, the arm 30 is moved downward to provide a safe distance between the detector 20 and the table 50 required for rotation of the arm 30 (operation S31). To determine whether rotation of the arm 30 is possible or not, the control unit 70 may use information about a height of the detector 20 from the ground with respect to previously input angles of the arm 30 and the detector 20. Alternatively, the control unit 70 may determine whether rotation of the arm 30 is possible or not using information about a distance between the table 50 and the detector 20 obtained from sensors attached to the arm 30 and the detector 20, or the height of the detector 20 from the ground.

If the arm 30 is in the rotatable state, the control unit 70 rotates the arm 30 (operation S40).

If the arm 30 is rotated, the detector 20 is angularly deviated from a horizontal orientation thereof. The control unit 70 corrects the angularly deviated detector 20 horizontally (operation S50). To this end, the control unit 70 may use information about an angular displacement required to keep the detector 20 in a horizontal orientation with respect to a previously input angle of the detector 20 after rotation of the arm 30. Alternatively, the control unit 70 may horizontally correct the angle of the detector 20 using information about a tilting degree of the detector 20 obtained from sensors attached to the arm 30 and the detector 20.

If the arm 30 is rotated, a distance between the detector 20 and the table 50 is changed as compared to a distance before rotation of the arm 30. The control unit 70 corrects the changed distance between the detector 20 and the table 50 after rotation of the arm 30 (operation S60). To this end, the control unit 70 may use information about the height of the detector 20 from the ground with respect to previously input angles of the arm 30 and the detector 20 after rotation of the arm 30. Alternatively, the control unit 70 may correct the distance between the detector 20 and the table 50 after rotation of the arm 30 using information about the distance between the detector 20 and the table 50 after rotation of the arm 30 obtained from sensors attached to the arm 30 and the detector 20, or the height of the detector 20 from the ground.

After completion of the above described control operation, the control unit 70 returns to operation S10 to repeat the above described control operation.

The control unit 70 may move the detector 20 to a desired position by repeatedly performing the above described control operation. Since a movement distance of the detector 20 resulting from a single control cycle is very short, the detector 20 may appear to smoothly move to a desired position while horizontally coming into close contact with the table 50. During the control operation, the control unit 70 may use information about movable ranges of the arm 30 and the detector 20 with respect to previously input angles of the arm 30 and the detector 20, or information about movable ranges of the arm 30 and the detector 20 obtained from sensors attached to the arm 30 and the detector 20, or may use a combination of the previously input information and the information obtained from the sensors.

The radiography apparatus and the control method thereof according to the exemplary embodiment may provide, e.g., full-body radiography of a patient.

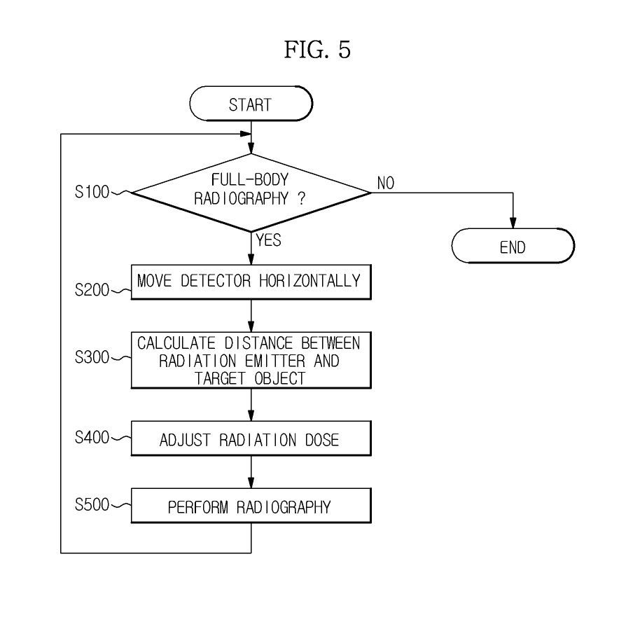

FIG. 5 is a flow chart illustrating the sequence of controlling full-body radiography by the control unit 70 according to the exemplary embodiment.

To perform full-body radiography on a target object, the control unit 70 first determines whether or not to perform full-body radiography (operation S100). If full-body radiography is chosen, the control unit 70 horizontally moves the detector 20 according to the above described movement control algorithm of the detector 20 (operation S200). As the detector 20 is horizontally moved, full-body radiography is performed under control of the control unit 70. To obtain an image having a predetermined resolution, it may be necessary for the radiation emitter 10 to provide an evenly distributed radiation dose throughout the object. Thus, the control unit 70 calculates a distance between the radiation emitter 10 and the object if a radiography command is input while the detector 20 is being horizontally moved (operation S300), adjusts the radiation dose based on the calculated distance (operation S400), and thereafter enables radiography of the object (operation S500). These operations S300 to S500 to radiograph the object using the evenly distributed radiation dose will be described hereinafter in more detail.

The control unit 70 may set a reference condition having a reference radiation dose based on a reference distance between the radiation emitter 10 and the object in a state in which the radiation emitter 10 is perpendicular to the table 50, i.e. has a radiation emitting angle of 90 degrees. Once the arm 30 is rotated, the distance between the radiation emitter 10 and the object deviates from the above described reference distance. If the reference radiation dose is used despite the changed distance between the radiation emitter 10 and the object, an image different from a reference image is obtained. That is, the image may have different densities, darkness, resolution or the like from the reference image. Thus, the control unit 70 may need to provide an evenly distributed radiation dose throughout the object by adjusting the radiation dose based on the variation of distance due to rotation of the arm 30.

To this end, the control unit 70 calculates a variation in the angle of the arm 30 caused when the arm 30 is rotated during horizontal movement of the detector 20. If the rotating angle of the arm 30 is calculated, the control unit 70 calculates a distance between the radiation emitter 10 and the object after rotation of the arm 30 based on the calculated rotating angle. Then, the control unit 70 adjusts the radiation dose to be emitted to the object based on the calculated distance, thereby providing an evenly distributed radiation dose throughout the object. Assuming that the above described reference distance is “x”, the reference radiation dose is “y”, and the arm 30 is rotated by an angle of θ, a distance between the radiation emitter 10 and the object is x/cos θ. Since the radiation dose is inversely proportional to the square of the distance, the radiation dose emitted under the control of the control unit 70 is y(cos θ/x)².

The control unit 70 may provide an evenly distributed radiation dose throughout the object by adjusting the radiation dose based on the variation of distance between the radiation emitter 10 and the object after rotation of the arm 30. Alternatively, the control unit 70 may provide an evenly distributed radiation dose throughout the object by adjusting a position of the radiation emitter 10 to correspond to the above described reference distance.

In a related art method of performing radiography on the entire object, after the user moves the detector to a desired position by manually adjusting the arm and the detector, a part of the object is radiographed, and after the detector is moved to another position via the above described operation, another part of the object is radiographed. This method inconveniently forces the user to manually perform all the above-described operations, and therefore, results in deterioration in radiography speed and operation accuracy.

However, the radiography apparatus according to the exemplary embodiment allows the user to simply input only the movement direction of the detector using the input unit 60 without manually operating the arm 30 and the detector 20, thereby enabling radiography of the object on a per position basis during movement of the detector 20.

For example, full-body radiography may be performed simply by inputting the movement direction of the detector 20 using the input unit 60 to move the detector 20 to a desired position selected by the user. Differently from the related art method, the detector 20 may be moved via only the above described simplified operation, thus enabling more convenient and accurate automated full-body radiography.

As is apparent from the above description, with a radiography apparatus and a control method thereof according to the exemplary embodiment, a detector may be horizontally moved as a user simply pushes an input button indicating movement directions of the detector, resulting in convenience in operation of the radiography apparatus. Further, this allows the user to accurately control a position of the detector, and also, enables rapid movement of the detector to a desired position and automated radiography throughout an object.

Although a few exemplary embodiments have been shown and described, it would be appreciated by those skilled in the art that changes may be made in these embodiments without departing from the principles and spirit of the inventive concept, the scope of which is defined in the claims and their equivalents.

What is claimed is:

1. A radiography apparatus comprising an arm to which a radiation emitter is coupled and a detector which records radiation passing through an object to form a radiography image, the apparatus further comprising:
an input unit which inputs a change in a position of the detector; and
a control unit which controls motors which drive the arm and the detector to move the detector in a direction input through the input unit.

2. The apparatus according to claim 1, wherein the detector is movable in a vertical direction and a horizontal direction.

3. The apparatus according to claim 1, wherein the arm is a U-shaped arm.

4. The apparatus according to claim 1, wherein the input unit includes a direction input device which inputs a movement direction of the detector.

5. The apparatus according to claim 1, wherein the control unit controls the motors by calculating a movement distance and a rotating angle of the arm and the detector.

6. A method of controlling a movement of a detector, the method comprising:
determining a rotating direction of an arm coupled to the detector based on a movement direction of the detector;
rotating the arm by a control unit based on a result of the determining, and correcting, by the control unit, a position of the detector after rotation of the arm is completed.

7. The method according to claim 6, wherein the rotation of the arm includes:
determining, by the control unit, whether the arm is rotatable in the determined rotating direction;
moving the arm downward by the control unit if the arm is not rotatable in the determined rotating direction; and
rotating the arm in the determined rotating direction by the control unit if the arm is rotatable in the determined rotating direction.

8. The method according to claim 6, wherein the correcting the position of the detector includes:
correcting, by the control unit, an angle of the detector, which is deviated from a horizontal direction due to the rotation of the arm; and
after correcting the angle of the detector, correcting, by the control unit, a height of the detector, which is vertically moved due to the rotation of the arm.

9. The method according to claim 6, wherein the control unit repeats the control operations of rotating the arm and correcting the position of the detector until the detector moves to an input position.

10. The method according to claim 6, wherein the control unit controls the movement of the detector based on information about movable ranges of the arm and the detector with respect to previously input angles of the arm and the detector.

11. The method according to claim 6, wherein the control unit controls the movement of the detector based on information about movable ranges of the arm and the detector obtained from sensors attached to the arm and the detector.

12. The method according to claim 6, wherein the control unit controls the movement of the detector based on a combination of information about movable ranges of the arm and the detector with respect to previously input angles of the arm and the detector and information about movable ranges of the arm and the detector obtained from sensors attached to the arm and the detector.

13. The method according to claim 6, wherein the arm is a U-shaped arm.

14. A method of performing full-body radiography on an object using a radiography apparatus, the method comprising:
horizontally moving a detector by a control unit if full-body radiography is selected; and
adjusting, by the control unit, a radiation dose emitted from a radiation emitter to provide an evenly distributed radiation dose throughout the object during horizontal movement of the detector.

15. The method according to claim 14, wherein evenly distributing the radiation dose throughout the object includes:
determining, by the control unit, a rotating angle of an arm;
calculating, by the control unit, a distance between the radiation emitter and the object after the arm is rotated by the determined rotating angle; and
adjusting, by the control unit, the radiation dose to provide the evenly distributed radiation dose throughout the object based on the calculated distance.

16. The method according to claim 14, wherein evenly distributing the radiation dose throughout the object includes adjusting, by the control unit, a distance between the radiation emitter and the object to a constant value to provide the evenly distributed radiation dose throughout the object.

17. A control method of a radiography apparatus, the method comprising:
simultaneously controlling, by a control unit, motors used to drive an arm and a detector if a movement direction of the detector is input through an input unit;
horizontally moving the detector in the inputted movement direction by controlling the motors by the control unit; and
performing radiography of an object after stopping a movement of the detector when the detector reaches a target position.

18. The method according to claim 17, wherein the arm is a U-shaped arm.

19. The method according to claim 17, wherein the detector is movable in a vertical direction and a horizontal direction.

20. A radiography apparatus which forms a radiography image, the apparatus comprising:
an arm to which a radiation emitter is coupled;
a detector which records radiation passing through an object to form the radiography image;
an input unit which inputs a change in a position of the detector; and
a control unit which controls motors which drive the arm and the detector to move the detector in a direction input through the input unit.

21. The apparatus of claim 20, wherein the detector is rotatably coupled to the arm.
